(19) United States
(12) Patent Application Publication
(10) Pub. No.: US 2010/0094752 A1
(43) Pub. Date: Apr. 15, 2010

(54) METHOD AND SYSTEM FOR MOBILE BANKING AND MOBILE PAYMENTS

(76) Inventor: Stephan HEATH, Englewood, CO (US)

Correspondence Address: Lesavich High-Tech Law Group, P.C., Suite 325, 39 S. LaSalle Street, Chicago, IL, 60603, US

(21) Appl. No.: 12/575,558

(22) Filed: Oct. 8, 2009

Related U.S. Application Data
(60) Provisional application No. 61/105,476, filed on Oct. 15, 2008.

(51) Int. Cl. G06Q 20/00; G06Q 40/00

(52) U.S. Cl. 705/40; 705/44

(57) ABSTRACT

A method and system for mobile banking and mobile payments is presented. A mobile device attempting a financial transactions receives an indication that the financial transaction has or has not been successfully completed via an electronic message and a unique “Financial Audio Communication System” (“FACM”) indication. A user of the mobile target device can determine whether the financial transaction has successfully completed or not by listening to the audio output generated from the FACM indication on the mobile target device and does not have to view textual information on the mobile target device.

### CROSS REFERENCES TO RELATED APPLICATIONS

This U.S. Utility patent application claims priority to U.S. Provisional patent application 61/105,476, filed Oct. 15, 2008, the contents of which are incorporated by reference.

### FIELD OF THE INVENTION

The invention relates to banking and electronic payments. More specifically, it relates to a method and system for mobile banking and mobile payments.

### BACKGROUND OF THE INVENTION

There is a paradigm shift that is occurring around the world with a move to a cashless society. There is also a tremendous growth of mobile phone and other mobile device usage and introduction of online mobile payment services, via such mobile devices. The mobile payment services industry is one of the fastest growing market niches recognized throughout the world. It has been estimated that there are currently more than 4.1 billion mobile device users in the world.

Mobile banking and payment technology allows consumers access to view balance information, transfer funds, schedule payments and receive alerts—among other activities, without logging onto the internet. By turning a cell phone into a “mobile wallet,” mobile banking and payment technology allows you to conveniently and securely complete two-way mobile banking and payment services making it possible to send money immediately to anyone, anywhere, with a mobile phone number. You can pay merchants, get paid instantly, get cash from ATMs and pay for online services and products with their mobile phones. Whether your teen is at the mall and needs money for clothes right now, your son or daughter is at college needs cash for books, or you just want a quick, easy and inexpensive way to pay your bills—you name it, you can send money to near and far in an instant, for your phone to theirs.

Commerce over mobile devices is accelerating in the U.S. and around the world. Juniper Research forecasts that over 800 million consumers will use mobile banking services by 2011, a tenfold increase in the number using such services as of 2007. According to the report, the annual number of global mobile banking transactions will rise from 2.7 billion in 2007 to 37 billion by 2011, as a greater number of services are deployed worldwide.

The Shosteck Group predicts that mobile marketing will be worth $10 billion in the U.S. along by 2010, 43 percent of U.S. marketers are using mobile marketing right now, according to Forrester Research. And nearly 90 percent of major brands plan to market to mobile phones by 2008, according to a survey by Airwide Solutions.

The move to a cashless society has been a topic of discussion for a long time. The advent of the Internet has revolutionized the way the financial services industry conducts business, empowering organizations with new business models and new ways to offer accessibility 7 days per week and 24 hours per day to their customers. The ability to offer financial transactions online has also created new players in the financial services industry, such as online banks, online brokers and wealth managers who offer personalized services, although such players still account for a tiny percentage of the industry.

Over the last few years, the mobile and wireless market has been one of the fastest growing markets in the world and it is still growing at a rapid pace. According to the a study by financial consultancy Celent, 25 percent of online banking households will be using mobile banking by 2010, up from less than 1 percent today. Upwards of 70 percent of bank center call volume is projected to come from mobile phones.

There are more than 4.1 billion people with mobile phones around the globe as of December 2008. Eighty percent of the world's population enjoys mobile phone coverage as of 2006. This figure is expected to increase to 90% by the year 2010. The Shosteck Group predicts mobile marketing will be worth $10 billion in the U.S. along by 2010, 43 percent of U.S. marketers are using mobile marketing right now, according to Forrester Research. And nearly 90-percent of major brands plan to market to mobile phones by 2008, according to a survey by Airwide Solutions.

The phenomenal growth and success of mobile payment sites like MobillCash, OboPay, PayByCash, PayPal Mobile, Amazon Payments and Google CheckOut are a true testament to the potential that exists for new mobile phone business. MobillCash, which was founded in 2003, is the world's leader in mobile payments reportedly has over 1.6 billion mobile phone users in fifteen countries around the world. PayByCash has partnered with MobillCash and added another popular payment method to its more than 70 alternative payment options. MobillCash allows those subscribers to simply enter their mobile phone number on MobillCash's billing form to purchase products or services. MobillCash's customers are billed by the mobile phone carrier.

OboPay, headquartered in Redwood City, Calif. and founded in 2005 currently operates in the U.S. and India and lets users fund their mobile account with cash or by linking up their credit cards or current account. Obopay is pioneering a mobile service that lets consumers and businesses purchase, pay and transfer money through a mobile phone. PayByCash, which was founded in 1998, has over 70 payment methods across 200 countries. PayByCash rolled out a mobile phone payment option for its online merchants and their mobile subscribers in the U.S., Netherlands, Belgium, U.K., Sweden, Norway, Germany, Ireland and Finland. PayByCash offers more than 70 payment methods with a global reach, typically with no merchants all the PayByCash payment options, including the Ultimate Game Card, the game industry's best known pre-paid card. PayByCash partnered with MobillCash in June 2009 to provide international mobile payment solution for multiplayer games and virtual worlds. Paying via mobile phones is common with the online gaming and downloadable services. Market research company, Jupiter Research, predicts 612 million mobile phone users will generate more than $587 billion worth of financial transactions in 2011.

The popularity of social networking sites such as Facebook, MySpace, Digg, Twitter, YouTube and Classmates continue to grow at an astounding rate. Facebook has become the Google of social networking having grown to a reported 200 million users. The main purpose of online social networking is to connect friends old and new and interact with people who have the same or similar interests. Members are often divided into groups or networks according to their institution or geographic location. “Social Shopping” is becoming popular through its mobile social services.

Countries like India, China, Bangladesh, Indonesia and Philippines, where mobile infrastructure is comparatively better than the fixed-line infrastructure, and in European countries, where mobile phone penetration is very high (at least 80 percent of consumers use a mobile phone), mobile banking is used more frequently.

Mobile payments have already been well adopted in many parts of Europe and Asia. According a report by Juniper Research, 2.1 billion mobile subscribers will pay-by-mobile for digital goods. Combined market for all types of mobile payments is expected to reach more than $600 billion by 2013, while mobile payment market for goods and services, excluding contactless NFC transactions (purchases made in physical stores or transportation services) and money transfers, is expected to exceed $300 billion globally by 2013.

The United Kingdom, Luxemberg and Hong Kong account for more mobile phones than people. Africa has the largest growth rate of mobile subscribers in the world, about twice as fast as Asia. There are approximately 225 million mobile phones in Indian and 100 million are added every year. In a few years, it is estimated that more than 500 million people are expected to have mobile phones in India. Millions of mobile phone users in developing countries who do not currently hold bank accounts or credit cards would like to have access to banking services at the right price. Many believe that mobile users have just started to fully utilize the data capabilities in their mobile phones.

China has approximately 1.3 billion people, which is about one fifth of the world's population. China has an estimated 679 million mobile subscribers. In a country with an estimated 679 million mobile phone users and very low credit card penetration, cracking the mobile payment market in China could prove to be very lucrative. According to Beijing-based tech and telecom consultancy Maverick China Research, 75% of mobile phone users do not have any access to mobile payment whatsoever. Of the 25% that do, less than 2% actually use mobile payment to conduct transactions. The one big player, UMPay, a collaborative effort from China Mobile and China UnionPay (operator of the country's ATM network), but it has yet to move much beyond traditional mobile billing. The steady growth of mobile phone users in China has created huge demands for mobile payments services for both personal and business applications.

In a country leading the statistics in mobile phone subscribers and very low credit card penetration, cracking the mobile payment market could prove to be very lucrative. According to Beijing-based tech and telecom consultancy Maverick China Research, seventy five percent of mobile phone subscribers in China do not have any access to mobile payment whatsoever. The steady growth of mobile phone subscribers in China has created huge demands for mobile payments services for both personal and business applications.

The United Kingdom, Luxembourg and Hong Kong account for more mobile phones than people. On a numerical basis India is the fastest growing with 6 million new subscribers per month and just under 18 percent penetration rate and is expected to reach 500 million in 2010. Africa has the largest growth rate of mobile subscribers in the world, about twice as fast as Asia. There are approximately 415 million mobile phones in Indian and 100 million are added every year. In a few years, it is estimated that more than 500 million people are expected to have mobile phones in India.

There is a huge potential to tap into foreign markets such as China and other markets by providing mobile payment services such as electronic payments, including credit and debt card processing, prepaid solutions, foreign currency, bank and post wire processing, stored value accounts and digital vouchers.

There are many problems associated such tremendous growth in online mobile marketing and advertising and so many consumers' worldwide owning mobile phones. One problem is that most online mobile payment and banking services used via mobile phones, PDAs and other mobile device are currently inadequate for anything by checking balances.

Thus, it is desirable to solve some the problems associated with mobile payment and banking services provided via mobile devices

### SUMMARY OF THE INVENTION

In accordance with preferred embodiments of the present invention, some of the problems associated with mobile banking and mobile payment systems are overcome. A method and system for mobile banking and mobile payments is presented.

A mobile device attempting a financial transactions receives an indication that the financial transaction has or has not been successfully completed via an electronic message and a unique “financial audio communication system” (“FACM”) indication. A user of the mobile target device can determine whether the financial transaction has successfully completed or not by listening to the audio output generated from the FACM indication on the mobile target device and does not have to view textual information on the mobile target device.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary mobile banking and payment system information system for electronic devices;

FIG. 2 is a flow diagram illustrating a method for determining a status of financial transactions via an audio indication; and

FIG. 3 is a flow diagram illustrating a method for determining a status of financial transactions via an audio indication;

FIG. 4 is a block diagram illustrating an exemplary electronic FACM tone object; and

FIG. 5 is a flow diagram illustrating a method for determining a status of financial transactions via an audio indication.

### DETAILED DESCRIPTION OF PREFERRED EMBODIMENTS

### Mobile Banking and Mobile Payment System

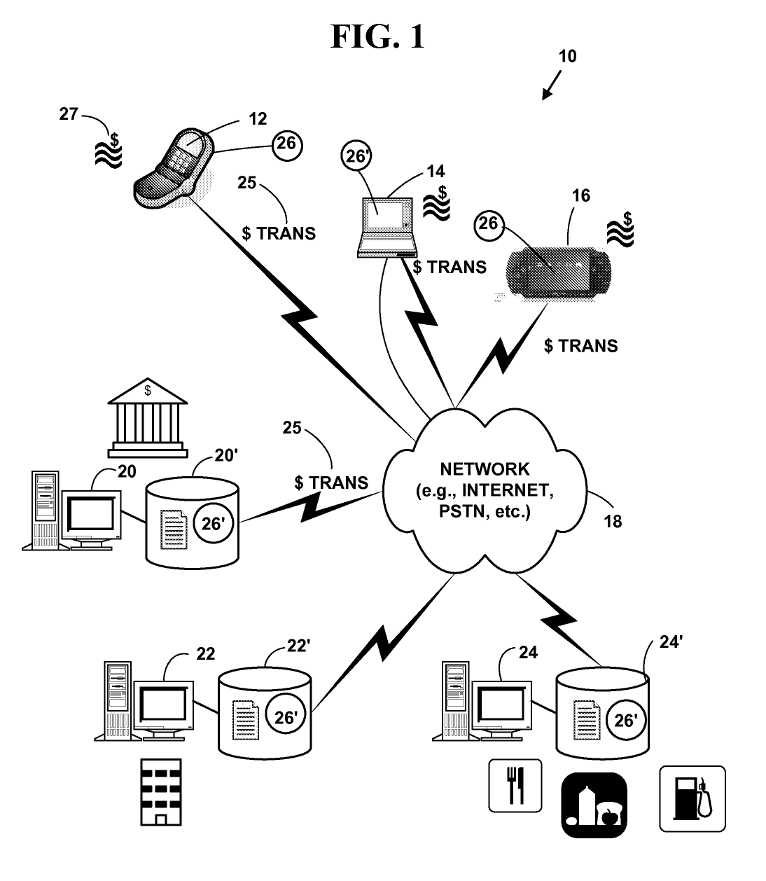

FIG. 1 is a block diagram illustrating an exemplary mobile banking and mobile payment system for electronic devices. The exemplary system 10 includes, but is not limited to, one or more target devices 12, 14, 16 (only three of which are illustrated). However, the present invention is not limited to these target electronic devices and more, fewer or others types of target electronic devices can also be used. The target devices 12, 14, 16 are in communications with a communications network 18. The communications includes, but is not limited to, communications over a wire connected to the target network devices, wireless communications, and other types of communications using one or more communications and/or networking protocols.

Plural server devices 20, 22, 24 (only three of which are illustrated) include one or more associated databases 20′, 22′, 24′. The plural network devices 20, 22, 24 are in communications with the one or more target devices 12, 14, 16 via the communications network 18. The plural server devices 20, 22, 24, include, but are not limited to, World Wide Web servers, Internet servers, file servers, other types of electronic information servers, and other types of server network devices (e.g., edge servers, firewalls, routers, gateways, etc.).

The plural databases 20′, 22′ and 24′ include plural Financial Audio Communication System (“FACM”) indications 25. The plural FACM indications 25 are used to generate one or more unique FACM tones 27 on an audio output portion of the one or more target devices 12, 14, 16.

The plural server devices 20, 22, 24 include, but are not limited to, servers used for storing electronic information for providing training (and help. etc.) for users of target devices 12, 14, 16. The one or more associated databases 20, 22, 24 include electronic information in plural digital formats, including, but not limited to, Hyper Text Markup Language (HTML), Extensible Markup Language (XML), Wireless Access Protocol (WAP), flash media, Java and various combinations thereof.

The one or more target devise 12, 14, 16 and the plural server devices 20, 22, 24 include a payment application 26. The payment application 26 may be a stand-alone application 26 that receives information via the communications network 18 or networking applications 26′ that includes two-way communications with other networking applications 26′ via the communications network 18. In one embodiment, the payment application 26 includes an application for a smart phone such as the iPhone by Apple, Inc.

In one embodiment, the networking application 26′ includes a server application 26′. The server applications 26′ include server applications for banks, other financial institutions, credit card companies, merchants, etc.

Applications 26, 26′ include software, hardware (e.g., ROM, Flash, etc.) firmware or other types of applications such as DVD's, audio files, etc.

In exemplary embodiment, the application 26 includes an automatic web-botic component that invades and imprints a mobile payment application 26 into an address book or other component of the mobile target device 12, 14, 16. As is known in the art, a web-bot is an automatic application used over communications networks 18 like the Internet, etc. In one embodiment, web-bots include dynamic objects on a web page that are executed when a web page is opened in a Web browser or selected (e.g., clicked on, etc.).

The target devices 12, 14, 16 include a protocol stack with multiple layers based on the Internet Protocol or OSI reference model.

As is known in the art, the Open Systems Interconnection (“OSI”) reference model is a layered architecture that standardizes levels of service and types of interaction for network devices exchanging information through a communications network. The OSI reference model separates network device-to-network device communications into seven protocol layers, or levels, each building- and relying—upon the standards contained in the levels below it. The OSI reference model includes from lowest-to-highest, a physical, data-link, network, transport, session, presentation and application layer. The lowest of the seven layers deals solely with hardware links; the highest deals with software interactions at the application-program level.

As is known in the art, the Internet Protocol reference model is a layered architecture that standardizes levels of service for the Internet Protocol suite of protocols. The Internet Protocol reference model comprises in general from lowest-to-highest, a link, network, transport and application layer.

The one or more target devices 12, 14, 16 include, but are not limited to, mobile phones 12. The one or more target devices 12, 14, 16 may also include personal laptop computers 14, mobile computers, desktop computers, Internet appliances, mobile phones, or other similar personal mobile electronic devices. Other or equivalent devices can also be used to practice the invention. The target devices 12, 14, 16, may also be replaced with other types of devices including, but not limited to, client terminals in communications with one or more servers, other types of mobile and non-mobile electronic devices.

The one or more target devices 12, 14, 16 may also include personal game playing devices 16 such as the Play Station Portable (PSP) by Sony, the Gameboy and DS by Nintendo, and others, digital/data assistants (PDAs), (e.g., Palm Pilot by Palm, etc.) personal audio/video devices, (e.g., Ipod by Apple, Zune by Microsoft, other MP3/video players, etc.) the Iphone by Apple, etc.

The communications network 18 includes, but is not limited to, the Internet, an intranet, a wired Local Area Network (LAN), a wireless LAN (WiLAN), a Wide Area Network (WAN), a Metropolitan Area Network (MAN), portions of a wired and/or wireless Public Switched Telephone Network (PSTN) and other types of communications networks 18.

The communications network 18 may include one or more gateways, routers, bridges and/or switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that shifts and/or exchanges data between network segments. Switches typically operate at the data link layer and sometimes the network layer therefore support many different data and/or voice protocols.

The communications network 18 may include one or more servers and one or more web-sites accessible by users to send and receive information useable by the one or more computers 12. The one or more servers may also include one or more associated databases for storing electronic information.

Preferred embodiments of the present invention include network devices that are compliant with all or part of standards proposed by the Institute of Electrical and Electronic Engineers (“IEEE”), International Telecommunications Union-Telecommunication Standardization Sector (“ITU”), European Telecommunications Standards Institute (ETSI), Internet Engineering Task Force (“IETF”), U.S. National Institute of Security Technology (“NIST”), American National Standard Institute (“ANSI”), Wireless Application Protocol (“WAP”) Forum, Data Over Cable Service Interface Specification (DOCSIS), Bluetooth Forum, or the ADSL Forum. However, network devices based on other standards could also be used. IEEE standards can be found on the World Wide Web at the Universal Resource Locator (“URL”) “www.ieee.org.” The ITU, (formerly known as the CCITT) standards can be found at the URL “www.itu.ch.” ETSI standards can be found at the URL “www.etsi.org.” IETF standards can be found at the URL “www.ietf.org.” The NIST standards can be found at the URL “www.nist.gov.” The ANSI standards can be found at the URL “www.ansi.org.” DOCSIS documents can be found at the URL “www.cablemodem.com.” Bluetooth Forum documents can be found at the URL “www.bluetooth.com.” WAP Forum documents can be found at the URL “www.wapforum.org.” ADSL Forum documents can be found at the URL “www.adsl.com.”

In one embodiment, the communications network 18 includes wired interfaces connecting portions of a PSTN or cable television network that connect the target devices 12, 14, 16 via one or more twisted pairs of copper wires including the varieties of digital subscriber line (DSL), coaxial cable, fiber optic cable, other connection media or other connection interfaces. The PSTN is any public switched telephone network provided by AT&T, GTE, Sprint, MCI, SBC, Verizon and others.

The communications network 18 also includes one or more different types of wireless interfaces that connect the target devices 12, 14, 16 wirelessly to communications network 18.

In one embodiment of the present invention, the wireless interfaces used for the plural target network devices 12, 14, 16 include but are not limited to, a paging and wireless messaging network, a cellular telephone network, a Packet Cellular Network (“PCN”) or Global System for Mobile Communications, (“GSM”), Generic Packet Radio Services (“GPRS”), or network/Personal Communications Services network (“PCS”), a Cellular Digital Packet Data (“CDPD”), Wireless Application Protocol (“WAP”) or Digital Audio Broadcasting (“DAB”) network or other types of wireless networks.

The wireless networks include, but are not limited to Code Division Multiple Access (“CDMA”), Time Division Multiple Access (“TDMA”), or other wireless technologies.

As is known in the art, PCS networks include network that cover a range of wireless, digital communications technologies and services, including cordless phones, mobile phones, voice mail, paging, faxing, mobile personal digital/data assistants (PDAs), etc. PCS devices are typically divided into narrowband and broadband categories.

Narrowband devices, which operates in the 900 MHz band of frequencies, typically provide paging, data messaging, faxing, and one- and two-way electronic messaging capabilities. Broadband devices, which operate in the 1850 MHz to 1990 MHz range typically provide two-way voice, data, and video communications. Other wireless technologies such as GSM, CDMA and TDMA are typically included in the PCS category.

As is known in the art, GSM is another type of digital wireless technology widely used throughout Europe, in Australia, India, Africa, Asia, and the Middle East. GSM is currently not widely used in the United States, but its use is growing. GSM is a wireless platform based on TDMA to digitize data. GSM includes not only telephony and Short Message Services (“SMS”) but also voice mail, call forwarding, fax, caller ID, Internet access, and e-mail. As is known in the art, SMS is type of communications service that enables a user to allow private message communications with another user.

GSM typically operates at three frequency ranges: 900 MHz (GSM 900) in Europe, Asia and most of the rest of the world; 1800 MHz (GSM 1800 or DCS 1800 or DCS) in a few European countries; and 1900 MHz (GSM 1900 also called PCS 1900 or PCS) in the United States. GSM also operates in a dual-band mode including 900/1800 Mhz and a tri-band mode include 900/1800/1900 Mhz.

As is known in the art, GPRS is a standard for wireless communications, which runs at speeds up to 150 kilo-bits-per-second (“kbit/s”). GPRS, which supports a wide range of bandwidths is an efficient use of limited bandwidth and is particularly suited for sending and receiving small bursts of data such as e-mail and Web browsing, as well as large volumes of data.

As is known in the art, CDPD is a wireless standard providing two-way, 19.2-Kbps or higher packet data transmission over existing cellular telephone channels. As is known in the art, a Packet Cellular Network (“PCN”) includes various types of packetized cellular data.

In one embodiment of the present invention, the wireless interfaces include but are not limited to, an IEEE 802.11a, 802.11b, 802.11g, 802.11n, “Wireless Fidelity” (“Wi-Fi”), IEEE 802.15.4 (Zigbee), “Worldwide Interoperability for Microwave Access”(“WiMAX”), ETSI High Performance Radio Metropolitan Area Network (HIPERMAN) or “Radio Frequency (RF) Home” wireless interfaces. In another embodiment of the present invention, the wireless sensor device may include an integral or separate Bluetooth (IEEE 802.15.1a) and/or infra-red data association (IrDA) module for wireless Bluetooth or wireless infrared communications. However, the present invention is not limited to such an embodiment and other 802.11xx and other types of wireless interfaces can also be used.

As is known in the art, 802.11b defines a short-range wireless network interface. The IEEE 802.11b standard defines wireless interfaces that provide up to 11 Mbps wireless data transmission to and from wireless devices over short ranges. 802.11a is an extension of the 802.11b and can deliver speeds up to 54M bps. 802.11g deliver speeds on par with 802.11a. However, other 802.11xx interfaces can also be used and the present invention is not limited to the 802.11 protocols defined. The IEEE 802.11a, 802.11b and 802.11g standards are incorporated herein by reference.

As is known in the art, Wi-Fi is another type of 802.11xx interface, whether 802.11b, 802.11a, dual-band, etc. Wi-Fi devices include an RF interfaces such as 2.4 GHz for 802.11b or 802.11g and 5 GHz for 802.11a. More information on Wi-Fi can be found at the URL www.weca.net.

As is known in the art, WiMAX is an industry trade organization formed by communications component and equipment companies to promote and certify compatibility and interoperability of broadband wireless access equipment that conforms to the IEEE 802.16xx and ETSI HIPERMAN. HIPERMAN is the European standard for MANs.

The IEEE The 802.16a and 802.16g standards are wireless MAN technology standard that provides a wireless alternative to cable, DSL and T1/E1 for last mile broadband access. It is also used as complimentary technology to connect IEEE 802.11xx hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the URL “www.wimaxforum.org.” WiMAX can be used to provide a wireless local loop (WLP).

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the URL “www.etsi.org.”

The communications network 18 also includes data networks using the Transmission Control Protocol (TCP), User Datagram Protocol (UDP), Internet Protocol (IP) and other data protocols.

The target devices 12, 14, 16 include a protocol stack with multiple layers based on the Internet Protocol or OSI reference model. The protocol stack includes, but is not limited to, TCP, UDP, IP, Hypertext Transfer Protocol (HTTP), Simple Mail Transfer Protocol (SMTP), Post Office Protocol version 3 (POP3), Internet Mail Access Protocol (IMAP), Voice-Over-IP (VoIP), Instant-Messaging (IM) Short Message Services (SMS) and other protocols.

TCP provides a connection-oriented, end-to-end reliable protocol designed to fit into a layered hierarchy of protocols that support multi-network applications. For more information on TCP 58 see RFC-793, incorporated herein by reference.

UDP provides a connectionless mode of communications with datagrams in an interconnected set of networks. For more information on UDP see ITEF RFC-768, incorporated herein by reference.

IP is an addressing protocol designed to route traffic within a network or between networks. For more information on IP 54 see IETF RFC-791, incorporated herein by reference. An IP address includes four sets of numbers divided by period (e.g., x.x.x.x) in the range of zero to 255. An IP address is a unique string of numbers that identifies a device on an IP based network.

HTTP is a standard protocol for communications on the World Wide Web. For more information on HTTP, see IETF RFC-2616, incorporated herein by reference.

SMTP is a protocol for sending e-mail messages between devices including e-mail servers. For more information on SMTP, see IETF RFC-821 and RFC-2821, incorporated herein by reference.

POP3 is a protocol for a protocol used to retrieve e-mail from a mail server. For more information on POP3, see IETF RFC-1939, incorporated herein by reference.

IMAP is a protocol for retrieving e-mail messages from a server. For more information on IMAP, see IETF RFC-1730, incorporated herein by reference.

EXtensible Markup Language (XML) is XML (Extensible Markup Language) is a markup language for data that allows information and services to be encoded with meaningful structure and semantics that computers and humans can understand. XML is used for information exchange, and includes user-specified and industry-specified tags. For more information on XML, see IETF RFC 3023.

Media Access Control (MAC) is a data link layer protocol. A MAC address is a physical address of a device connected to a communications network, expressed as a 48-bit hexadecimal number. A MAC address is permanently assigned to each unit of most types of networking hardware, such as network interface cards (NICs), by manufacturers at the factory.

VoIP is a set of facilities for managing the delivery of voice information using IP 28 packets. In general, VoIP is used to send voice information in digital form in discrete data packets (i.e., IP 28 packets) over data networks 18 rather than using traditional circuit-switched protocols used on the PSTN. VoIP is used on both wireless and wired data networks.

VoIP typically comprises several applications (e.g., SIP, SLP, H.323, H.324, DNS, AAA, etc.) that convert a voice signal into a stream of packets (e.g., IP 28 packets) on a packet network and back again. VoIP allows voice signals to travel over a stream of data packets over a communications network 18.

As is known in the art, Session Initiation Protocol (SIP) supports user mobility by proxying and re-directing requests to a mobile node's current location. Mobile nodes can register their current location. SIP is not tied to any particular conference control protocol. SIP is designed to be independent of a lower-layer transport protocol and can be extended. For more information on SIP, see IETF RFC-2543, the contents of which are incorporated herein by reference.

As is known in the art, Service Location Protocol (SLP) provides a scalable framework for the discovery and selection of network services. Using SLP, network devices using the Internet need little or no static configuration of network services for network based applications. For more information on SLP see IETF RFC-2608, incorporated herein by reference.

As is known in the art, H.323 is one of main family of video conferencing recommendations for IP networks. The ITU-T H.323 standards entitled “Packet-based multimedia communications systems” dated February 1998, September 1999, November 2000 and July 2003 are incorporated herein by reference.

As is known in the art, H.324 is a video conferencing recommendation using Plain Old Telephone Service (POTS) lines. The ITU-T H.324 standards entitled “Terminal for low bit-rate multimedia communication” dated February 1998 and March 2002 are incorporated herein by reference.

As is known in the art, a Domain Name System (DNS) provides replicated distributed secure hierarchical databases that hierarchically store resource records under domain names. For more information on the DNS see IETF RFC-1034, RFC-1035, RFC-1591, RFC-2606 and RFC-2929, the contents of all of which are incorporated herein by reference.

As is known in the art, Authentication Authorization and Accounting (AAA) includes a classification scheme and exchange format for accounting data records (e.g., for call billing, etc.). For more information on AAA applications, see, IETF RFC-2924, the contents of which are incorporated herein by reference.

VoIP services typically need to be able to connect to traditional circuit-switched voice networks such as those provided by the PSTN. Thus, VoIP is typically used with the H.323 protocol and other multimedia protocols. H.323 and H.324 terminals such as multimedia computers, handheld devices, PDAs or other devices such as non-mobile and mobile phones connect to existing wired and wireless communications networks 18 as well as private wired and wireless networks.

H.323 and H.324 terminals implement voice transmission functions and typically include at least one voice codec (e.g., ITU-T CODECS, G.711, G.723, G.726, G.728, G.729, GSM, etc.) that sends and receives packetized voice data and typically at least one video codec (e.g., MPEG, etc.) that sends and receives packetized video data).

An Instant Message (IM) is a “short,” real-time or near-real-time message that is sent between two or more end user devices such (computers, personal digital/data assistants (PDAs) mobile phones, etc.) running IM client applications. An IM is typically a short textual message. Examples of IM messages include America Online's Instant (AIM) messaging service, Microsoft Network (MSN) Messenger, Yahoo Messenger, and Lycos ICQ Instant Messenger, IM services provided by telecom providers such as T-Mobile, Verizon, Sprint, and others that provide IM services via the Internet and other wired and wireless communications networks. In one embodiment of the present invention, the IM protocols used meet the requirements of Internet Engineering Task Force (IETF) Request For Comments (RFC)-2779, entitled “Instant Messaging/Presence Protocol Requirements.” However, the present invention is not limited to such an embodiment and other IM protocols not compliant with IETF RFC 2779 may also be used.

Lightweight Directory Access Protocol (LDAP) is a software protocol for enabling anyone to locate organizations, individuals, and other resources such as files and devices in a network, whether on the public Internet or on private intranet or other communications network 18. LDAP is a “lightweight” version of Directory Access Protocol (DAP), which is part of X.500, a standard for directory services in a network.

An operating environment for the devices of the exemplary system 10 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals by the CPU or processor. An electrical system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Security and Encryption

Devices and interfaces of the present invention include security and encryption for secure communications and secure recording of information. Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

As is known in the art, RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11x WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i is based on 802.1x port-based authentication for user and device authentication. The 802.11i standard includes two main developments: Wireless or Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry

The NIST developed a new encryption standard, the Advanced Encryption Standard (AES) to keep government information secure. AES is intended to be a stronger, more efficient successor to Triple Data Encryption Standard (3DES). More information on NIST AES can be found at the URL www.nist.gov/aes.

As is known in the art, DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

As is known in the art, RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

As is known in the art, “hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <264 bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

As is known in the art, providing a way to check the integrity of information transmitted over or stored in an unreliable medium such as a wireless network is a prime necessity in the world of open computing and communications. Mechanisms that provide such integrity check based on a secret key are called “message authentication codes” (MACS). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

As is known in the art, an Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

As is known in the art, Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference. However, the present invention is not limited to the security or encryption techniques described and other security or encryption techniques can also be used.

As is known in the art, the HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

As is known in the art, the SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security method are negotiated between the source and destination at the start of establishing a protocol session. The SSL 2.0 protocol specification, by Kipp E. B. Hickman, 1995 is incorporated herein by reference. More information on SSL is available at the URL See “netscape.com/eng/security/SSL_{—}2.html.”

As is known in the art, Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, Calif. is supplier of networking hardware and software, including router and security products.

### Audio Mobile Banking and Mobile Payments

The method and system described herein present a mobile device payment method and system for effectuating an electronic online payment through a mobile device equipped carrier or a mobile device equipped bank using a mobile user's device 12, 14, 16 (e.g., mobile telephone, PDA, laptop computer, etc.) receiving a confirmation that a financial transaction has or has not been completed via an electronic message and a “Financial Audio Communication System” (“FACM”) confirmation.

A user of a mobile device 12, 14, 16 via an application 26 can also select a different FACM “voice recognition”, “customized” or “unique” sound for each financial request and/or banking function. Mobile phone users will be able to send money, make a payment online, perform banking services, administer accounts, balance checking accounts, complete a purchase, stock financial transactions or m-commerce financial transactions via a mobile carrier or bank with or without a debit or credit card or checking account using their mobile telephone, PDA, computer or other devices.

The method and system include a computer-implemented method of effectuating an electronic on-line payment, money transfer, banking function, purchase, or stock financial transaction with a mobile carrier or a bank using a mobile user's telephone, PDA, computer or other mobile devices and receiving an electronic message and an FACM confirmation from a server corresponding to a payor, with a unique code logarithm, containing a payment request represent a payment amount sent by a payor device operating independently of the computer server system, determining a payment amount associated with a message and debiting a payor account for an amount corresponding to the amount of the payment request, and crediting an amount of a payee that is independent of the computer server system.

A secure mobile payment method via application 26 is included that allows the user to determine whether a financial transaction was completed or not through a FACM “voice recognition command,” a “customized single or double beep,” or other “unique sound.” A payment amount is validated, debited from the user's account and communicated from server to server for commercial and/or financial institutions. Confirmation that payment had been received is also simultaneously be sent to the relevant party and mobile user in the form of an “electronic” message and FACM confirmation indicating that a financial transaction has or has not been successfully completed.

In one embodiment, the application 26 also includes a description for a core functionality that would require users to download a small icon to their mobile phone, PDA, computer or other mobile devices 12, 14, 16, that would then be associated with a payment method plus a password and a secure authentication approach (e.g., encryption, other security, biometrics, etc.). The biometrics include biometric readers such as iris scan readers, fingerprint readers, facial recognition readers, and other biometric readers.

A financial server application 26′ is installed or downloaded in a financial institutions website or retailer's Point-of-Sale (POS) system. The server application 26′ includes a variety of trusted applications that can handle a variety of financial transactions and financial payments, including via auction, between a person and a business. The application 26′ also includes the ability to update a credit limit or bank account balance that the consumer could still use, the consumer's age and date/time stamp. Each credit/debit cardholder will receive a unique code algorithm, which is only known by the bank/issuer/processor that provides a unique encrypted validation code for each financial transaction.

The application 26 also includes a description to allow mobile users to share the application 26 with the names in the consumer's mobile phone, PDA, computer or other devices address book by simply clicking “share” when they enroll in our mobile payment and banking solution. A viral widget will then be sent to the all of the names in the user's mobile phone, PDA, computer or other devices with a link to download the application.

The application also includes a description to allow mobile users to participate in a “mobile social networking” environment sharing similar interests, conversing and connecting with one another using their mobile phones, PDA, computer or other devices. Members will be able to create a profile, make friends, participate in chat rooms, create chat rooms, hold private conversations, share photos and videos, share blogs by using their mobile phones, PDA, computer or other devices.

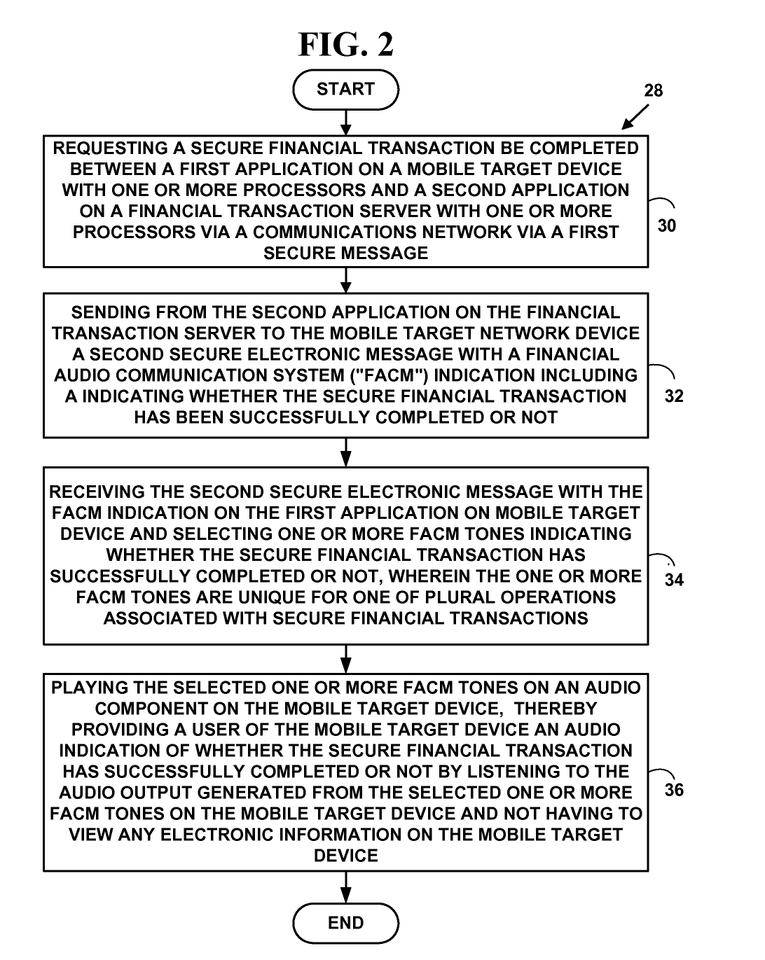

FIG. 2 is a flow diagram illustrating a Method 28 for determining a status of financial transactions via an audio indication. At Step 30, a secure financial transaction is requested with a first secure message between a first application on a mobile target device with one or more processors and a second application on a financial transaction server with one or more processors via a communications network. At Step 32, the second application on the financial transaction server securely sends to the mobile target network device a second secure electronic message with an Financial Audio Communication System (“FACM”) indication including a indicating whether the secure financial transaction has been successfully completed or not. At Step 34, the second secure electronic message with the FACM indication is securely received on the first application on mobile target device and one or more FACM tones are selected indicating whether the secure financial transaction has successfully completed or not. The one or more FACM tones are unique for operations associated with secure financial transactions. At Step 36, the selected one or more FACM tones are played on an audio component on the mobile target device, thereby providing a user of the mobile target device an audio indication of whether the secure financial transaction has successfully completed or not by listening to the audio output generated from the FACM tone on the mobile target device and not having to view textual or other electronic information on the mobile target device.

Method 28 is illustrated with an exemplary embodiment. However, the present invention is not limited to this embodiment and other embodiments can also be used to practice the invention.

In such an exemplary embodiment at Step 30, a secure financial transaction is requested with a first secure message between a first application 26 on a mobile target device 12, 14, 16 with one or more processors and a second application 26′ on a financial transaction server 20, 22, 24 with one or more processors via a communications network 18.

At Step 32, the second application 26′ on the financial transaction server 20 securely sends to the mobile target network device 12, 14, 16 a second secure electronic message with the FACM indication 25 including a indicating whether the secure financial transaction has been successfully completed or not.

At Step 34, the second secure electronic message with the FACM indication 25 is securely received on the first application 26 on mobile target device 12, 14, 16 and one or more FACM tones 27 are selected indicating whether the secure financial transaction has successfully completed or not. The one or more FACM tones 27 are unique for operations associated with secure financial transactions.

At Step 36, the selected one or more FACM tones 27 are played on an audio component on the mobile target device 12, 14, 16, thereby providing a user of the mobile target device 12, 14, 16 an audio indication of whether the secure financial transaction has successfully completed or not by listening to the audio output generated from the FACM indication 25 on the mobile target device 12, 14, 16 and not having to view textual or other electronic information on the mobile target device 12, 14, 16.

In one embodiment, the audio output is heard on the mobile target device 12, 14, 16, in a manner in which an incoming call, text message, instant message or electronic mail is delivered. In other words, the secure financial transaction is requested and a user of the mobile target device 12, 14, 16, can put the device down and be at a distance from the mobile target device 12, 14, 16 and still determine in an audio manner whether or not the secure financial transaction was completed.

In one embodiment, the FACM tones 27 include plural unique tones including unique tones for on-line payments, money transfer, banking functions, credit card transactions, debit card transactions, point-of-sale purchases, stock transactions, or commodity transactions and other types of transactions.

In one embodiment, for point-of-sale transactions, the FACM tones 27 are unique for purchases made in retail stores, grocery stores, convenience stores, gas stations, vending machines, fast food restaurants, etc.

In one embodiment, each financial institution, retail store, etc. has a unique set of FACM tones 27 associated with it. For example, Bank-A would have a unique set of FACM tones 27 and Bank-B would have another, different unique set of FACM 27 tones. This allows a user of a mobile target device to distinguish between financial transactions between banks via unique audio tones.

In one embodiment, a user can record his/her own unique tones or audio output to be used with the plural FACM indications 25.

In one embodiment, a mapping between the plural FACM indications 25 and the one or more FACM tones 27 is one-to-one. In another embodiment, a mapping between the plural FACM indications 25 and the one or more FACM tones 27 is one-to-many. In another embodiment, a mapping between the plural FACM indications 25 and the one or more FACM tones 27 is many-to-one.

In one embodiment, a secure electronic message is also sent to the mobile target device 12, 14, 16 as a confirmation of the secure financial transaction. In one embodiment, the secure electronic message also includes an embedded electronic object. The electronic message includes an electronic mail message, an instant message, a text message, a graphical message, a video message, a voice mail message or other types of electronic messages with embedded electronic objects. The embedded electronic objects, include, but are not limited to, HTML, XML, Java, multi-media and other types of electronic objects.

In one exemplary embodiment, the electronic mail message, instant message, text message, video message, graphical message or voice mail message also include an embedded electronic object including the FACM indication 25 to play one or more FACM tones 27 on an audio component on the mobile target device 12, 14, 16.

In one embodiment, the FACM indication 25 is used to generate audio-visual indication via the first application 26 on the mobile target device that provides and audio-visual indication of whether the secure financial transaction has successfully completed or not. For example, the audio-visual indication may be included in an application for a mobile smart phone such as the iPhone, by Apple, Inc. of Cupertino, Calif., and other similar devices.

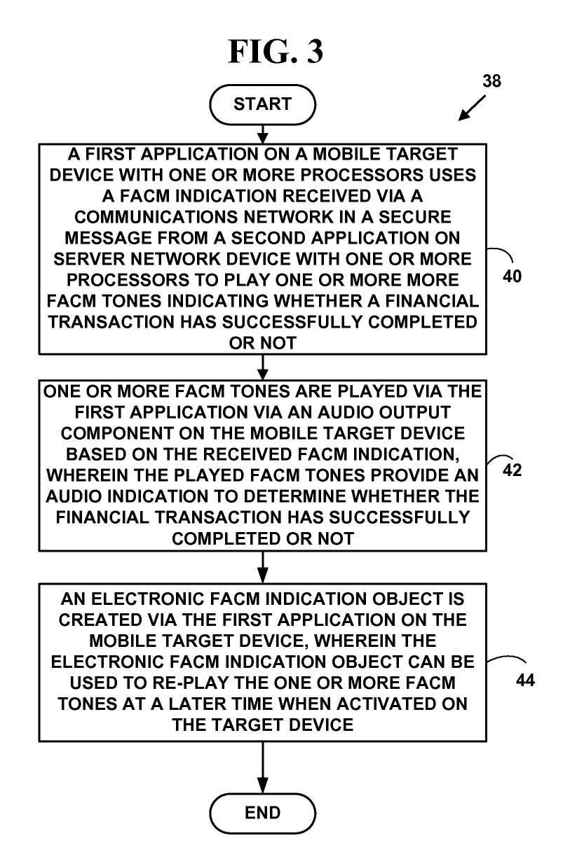

FIG. 3 is a flow diagram illustrating a Method 38 for determining a status of financial transactions via an audio indication. At Step 40, a first application on a mobile target device with one or more processors uses a FACM indication received in a secure electronic message from a second application on a server network device with one or more processors via a communications network to play one or more FACM tones indicating whether a financial transaction has successfully completed or not. At Step 42, the first application plays one or more appropriate FACM tones based on the received FACM indication via audio output generated on the mobile target device. The played FACM tones can be used to determine whether the financial transaction has successfully completed or not. At Step 44, an electronic FACM indication 25 object is created via the first application on the mobile target device. The electronic FACM indication object 25 includes an embedded electronic object that is used to re-play the FACM tone at a later time when activated on the target device.

Method 38 is illustrated with an exemplary embodiment. However, the present invention is not limited to this embodiment and other embodiments can also be used to practice the invention.

In such an exemplary embodiment at Step 40, a first application 26 on a mobile target device 12, 14, 16 with one or more processors uses a FACM indication 25 received via the communications network 18 in a secure message from a server network device 20, 22, 24 with one or more processors to play one or more FACM tones 25 indicating whether a financial transaction has successfully completed or not.

At Step 42, one or more FACM tones 27 are played via the first application 26 based on the received FACM indication 25 via an audio output component generated on the mobile target device 12, 14, 16. The played FACM tones 27 can be used to determine whether the financial transaction has successfully completed or not.

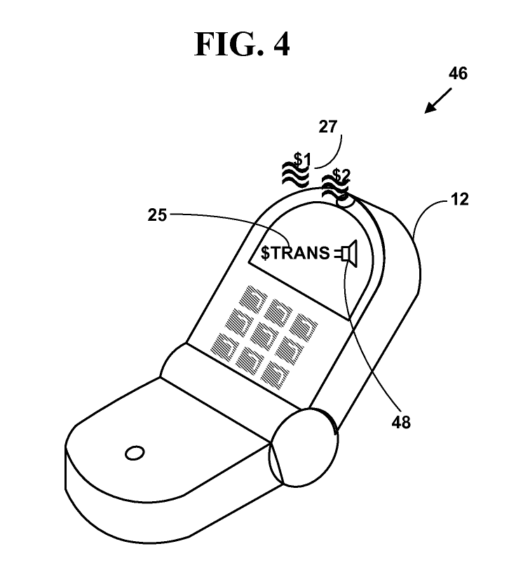

FIG. 4 is a block diagram illustrating an exemplary electronic 46 FACM tone object 48.

Returning to FIG. 3, at Step 44, an embedded electronic FACM tone 27 object 48 is created via the first application 26 on the mobile target device 12, 14, 16. The embedded electronic FACM tone 27 object 48 is used to re-play the FACM tone 27 at a later time when activated on the target device 12, 14, 16 (e.g. by selecting it by clicking on it, etc.). In one embodiment, the electronic FACM tone 27 object 48 is created as a graphical icon available on a display component on the mobile target device 12, 14, 16.

In one embodiment, the embedded electronic FACM tone 27 object 48 includes an embedded audio object. The embedded audio object can be selected and activated by clicking, etc. and when selected re-plays the one or more FACM tones 27. In another embodiment, the electronic FACM tone 27 object 48 includes an embedded audio-visual object. The embedded audio-visual object can be selected and activated by clicking, etc. and when selected re-plays the one or more FACM tones 27.

However, the present invention is not limited to the embedded objects described and more fewer and other types of embedded objects can be used to practice the invention. In another embodiment, the electronic FACM tone 27 object is not an embedded object.

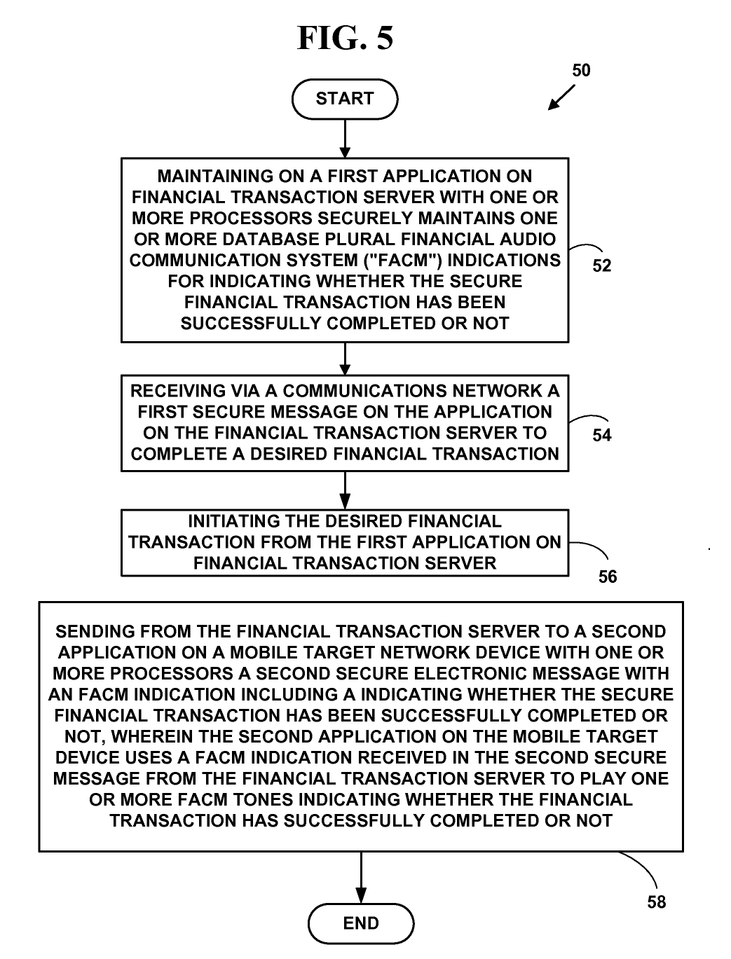

FIG. 5 is a flow diagram illustrating a Method 50 for determining a status of financial transactions via an audio indication. At Step 52, a first application on financial transaction server with one or more processors securely maintains one or more databases with plural Financial Audio Communication System (“FACM”) indications for indicating whether the secure financial transaction has been successfully completed or not. At Step 54, a first secure message is received via a communications network on the first application on the financial transaction server to complete a desired financial transaction for a mobile network device with one or more processors. At Step 56, the desired financial transaction is initiated from first application on the financial transaction server. At Step 58, the financial transaction server securely sends to the mobile target network device a second secure electronic message with a FACM indication including a indicating whether the secure financial transaction has been successfully completed or not, wherein a second application on the mobile target device uses a FACM indication received in the second secure message from the financial transaction server to play one or more FACM tones indicating whether a financial transaction has successfully completed or not.

Method 50 is illustrated with an exemplary embodiment. However, the present invention is not limited to this embodiment and other embodiments can also be used to practice the invention.

In such an exemplary embodiment at Step 52, an application 26′ on financial transaction server 20, 22, 24 with one or more processors securely maintains one or more databases 20′, 22′, 24′ with plural Financial Audio Communication System (“FACM”) indications 25 for indicating whether the secure financial transaction has been successfully completed or not.

At Step 54, a first secure message is received via the communications network 18 on the application 26′ on the financial transaction server 20, 22, 24 to complete a desired financial transaction for a mobile target device 12, 14, 16 with one or more processors.

At Step 56, the desired financial transaction is initiated from the first application 26′ on financial transaction server 20, 22, 24.

At Step 58, the second application 26′ on the financial transaction server 20, 22, 24, securely sends to mobile target network device 12, 14, 16 a second electronic message with one an FACM indication 25 including a indicating whether the secure financial transaction has been successfully completed or not. The first application 26 on the mobile target device 12, 14, 16 uses the FACM indication 25 received in the secure message from the server network device 20, 22, 24 to play one or more FACM tones 27 indicating whether the desired financial transaction has successfully completed or not.

The following examples illustrate various data flows for Methods 28 and 36 for processing a financial transaction using a mobile telephone, PDA, computer or other devices 12, 14, 16, through a mobile carrier 20, 24, 26 without the use of a debit or credit card or through a bank with the use of a debit or credit card or checking account and receiving an electronic message and an FACM confirmation that the financial transaction has or has not been completed. However, the present invention is not limited to these examples and more, fewer or other examples can also be used to illustrate and/or practice the invention.

### Example 1

Once a user downloads the application 26 to their mobile telephone, PDA, computer or other devices, 12, 14, 16 they will be able to send money, transfer funds, perform banking services, administer accounts, balance checking account, make payments, stock monitoring or make a purchase through a mobile carrier or a bank 20, 22, 24 with the use of a debit or credit card or checking account. After the financial transaction is completed, the mobile user will receive a secure electronic message and a FACM indication 25 indicating that the transaction has been successfully completed. Alternatively if the transaction has not been completed, the mobile user will receive a secure electronic message and another FACM indication 25′ indicating that the financial transaction has not been completed.

Table 1 illustrates an exemplary series of steps for Example 1. However, the present invention is not limited to this exemplary series of steps and more, fewer and other steps can also be used to practice the invention.

TABLE 1
1. User downloads mobile banking and payment application program 26 (with icon) to their
mobile telephone, PDA, computer 12, 14, 16.
2. Establish a user name, password and PIN number.
3. Each user or cardholder will be assigned a unique code number.
4. Each user will have the option of sharing the application 26 with their friends by clicking
“share” when they enroll in mobile payment and banking solution. (A mobile widget will then
be sent to all of the names in the user's address book).
5. Payor will record a “voice recognition command”, select a “customized beep,” or have a
“unique sound” generated that is used when a financial transaction has been successfully
completed.
6. Payor will record a “voice recognition command”, select a “customized double beep,” or
have “unique sound” generated that is used when a financial transaction has not been
completed.
7. Payor can now securely send money, make a payment online, perform banking services,
administer accounts, balance checking accounts, complete a purchase, stock financial
transaction or other m-commerce financial transaction via their mobile telephone, PDA,
computer or other devices 12, 14, 16.

### Example 2

A payor sends money to a third party 20, 24, 26 via a mobile carrier without the use of a debit or credit card or checking account using their mobile telephone, PDA, computer or other devices 12, 14, 16. After completing the transaction, the mobile user will receive a secure electronic message and a FACM indication 25 indicating that financial transaction has been successfully completed. Alternatively if the transaction has not been completed, the mobile user will receive a secure electronic message and another FACM indication 25′ indicating that the financial transaction has not been completed.

Table 2 illustrates an exemplary series of steps for Example 2. However, the present invention is not limited to this exemplary series of steps and more, fewer and other steps can also be used to practice the invention.

TABLE 2
1. Payor sends secure electronic payment request via mobile carrier 20, 22 using their mobile
telephone, PDA, computer or other devices 12, 14, 16 to a third party.
2. Data storage 24 server receives financial request and assigns to financial transaction and
sends electronic message to mobile carrier's server 20, 22.
3. Electronic payment is made to third party.
4. The mobile carrier's server 20, 22, receives financial request, verifies user's information,
authentication that corresponds to a payor, with a unique code, including a payment request
represent a payment amount sent by a payor device operating independently of the computer
server system, determining a payment amount associated with a message and debiting a
payor account for an amount corresponding to the amount of the payment request, and
crediting an amount of a payee that is independent of the computer server system. Financial
transaction is approved and funds are electronically sent to third party via a clearing house.
5. Mobile carrier's server 20, 22 sends secure electronic message and unique code indicating
to data storage server 24 in indicating that the financial transaction has been completed.
6. Data storage server 24 in sends a secure electronic message and unique code indicating
that the financial transaction has been completed.
7. Payor receives a secure electronic message, the unique code and unique FACM indication
25 via their mobile telephone, PDA, computer or other devices 12, 14, 16 indicating that the
financial transaction was approved. A record of the financial transaction will be included on the
payor's mobile device bill at the end of the billing cycle.
8. The unique FACM indication 25 is used to generate one or more FACM tones 27 on an
audio component of the device 12, 14, 16.

### Example 3

A payor makes a payment to a third party via a bank with the use of a debit or credit card or checking account using their mobile telephone, PDA, computer or other devices 12, 14, 16. After the transaction has been completed, the mobile user will receive a secure electronic message and a FACM indication 25 indicating that financial transaction has been successfully completed. Alternatively if the transaction has not been completed, the mobile user will receive a secure electronic message and another FACM indication 25′ indicating that the financial transaction has not been completed.

Table 3 illustrates an exemplary series of steps for Example 3. However, the present invention is not limited to this exemplary series of steps and more, fewer and other steps can also be used to practice the invention.

TABLE 3
1. Payor sends a secure financial request to pay a third party via a bank 20, 22 using their
mobile telephone, PDA, computer or other devices 12, 14, 16.
2. Data storage server 24, receives financial request to make a payment to a third party,
assigns a unique set of codes to financial transaction and sends an electronic message to
bank's server 20, 22.
3. Bank's server 20, 24 receives financial request, verifies user's information, authentication
and codes that corresponds to a payor, with a unique code logarithm, including a payment
request represent a payment amount sent by a payor device operating independently of the
computer server system 20, 24 determining a payment amount associated with a message
and debiting a payor account for an amount corresponding to the amount of the payment
request, and crediting an amount of a payee that is independent of the computer server
system. Financial transaction has been approved and the bank sends the funds electronically
to third party via a clearing house.
4. Bank's server 20, 22 sends electronic message and unique code to data storage server 24
indicating that the financial transaction has been completed.
5. Data storage server 24 sends an electronic message, the unique code and a unique FACM
indication 25 to user's mobile telephone, PDA, computer or other devices 12, 14, 16 indicating
that the financial transaction has been completed.
6. Payor receives electronic message and unique code via their mobile telephone, PDA,
computer or other devices 12, 14, 16 along with a FACM indication 25 indicating that the
financial transaction has been completed.

Table 4 illustrates an exemplary functionality for data storage server 24. However, the present invention is not limited to this exemplary functionality and more, fewer and other steps can also be used to practice the invention.

TABLE 4
1. Data storage server 24 receives a secure financial request from payor to perform a financial
request i.e. send money, make a payment online, perform banking services, administer
accounts, balance checking accounts, complete a purchase, stock financial transactions or m-
commerce or other financial transactions.
2. Data storage server 24 verifies user's information and authentication.
3. Data storage server 24 assigns a unique code to the financial transaction.
4. Data storage server 24 sends a secure electronic message and unique code to mobile
carrier's server in or to bank's server.
5. If the financial transaction is approved, the data storage server 24 will receive a secure
electronic message and unique code from the mobile carrier's server 20, 22 or bank's server
20, 22 indicating that the financial transaction has been completed.
6. The data server 24 transmits a secure electronic message and unique FACM indication 25
to user's mobile telephone, PDA, computer or other devices 12, 14, 16 indicating that the
financial transaction has or has not been successfully completed.
7. If the financial transaction is not approved, the data storage server 24 will receive a secure
electronic message and another unique FACM indication 25 to user's mobile telephone, PDA,
computer or other devices 12, 14, 16 indicating that the financial transaction has not been
approved.

Table 5 illustrates an exemplary functionality for data storage server 24. However, the present invention is not limited to this exemplary functionality and more, fewer and other steps can also be used to practice the invention.

TABLE 5
1. Mobile carrier's server 20, 22 receives a financial request along with unique code from data
storage server in 24.
2. Mobile carrier's server 20, 22 verifies payor's information, authentication, availability of
funds and/or credit limit to complete the financial transaction.
3. If the financial transaction is approved, the mobile carrier's server 20, 22 will send payment
to a third party through a clearing house and simultaneously send an electronic message and
unique code to data storage server in 24.
4. If the financial transaction is not approved, the mobile carrier's server 20, 22 will send an
electronic message and unique code to third party and data storage server in 24 indicating
that the financial transaction has not been completed.

Table 6 illustrates an exemplary functionality for bank and mobile carrier servers 20, 22. However, the present invention is not limited to this exemplary functionality and more, fewer and other steps can also be used to practice the invention.

TABLE 6
1. Bank's server 20, 22 receives a financial request along with unique code from data storage
server 24.
2. Bank's server 20, 22 verifies payor's information, authentication, availability of funds and/or
credit limit to complete the financial transaction.
3. Bank's server 20, 22 acknowledges unique code corresponding to the financial transaction.
4. If the financial transaction is approved, the data storage server 24 receives an electronic
message and unique code from the mobile carrier's server 20, 24 or bank's server in 20, 24
indicating that the financial transaction was approved. The data server 24 transmits an
electronic message and unique code to user's mobile telephone, PDA, computer or other
devices 12, 14, 16 indicating that the financial transaction has been completed.
5. If the financial transaction is not approved, the data storage server 24 will receive an
electronic message and unique code from the mobile carrier's server 20, 22 or bank's server
20, 22 indicating that the financial transaction has not been completed.

Table 7 illustrates an exemplary functionality for a clearing house used with the invention. However, the present invention is not limited to this exemplary functionality and more, fewer and other steps can also be used to practice the invention.

TABLE 7
1. If the financial transaction is approved, either the mobile carrier's server 20, 22 (via a
payment from the mobile carrier) or the bank's server 20, 22 will send an electronic payment
(via debit or credit card or checking account) to a third party through a clearing house and
simultaneously send an electronic message along with confirmation to third party and data
storage server 24 indicating that the financial transaction has been successfully completed.
2. If the financial transaction is not approved, either the mobile carrier's server in 20, 22 or the
bank's server 20, 22 will not send an electronic payment to a third party through a clearing
house and simultaneously send an electronic message along with confirmation to third party
and data storage server 24 indicating that the financial transaction has not been completed.

The present invention is not limited to the examples described in Table 1-7 and other scenarios can also be used to practice the invention.

The methods and systems describe herein provide for mobile banking and mobile payments. A mobile device attempting a financial transactions receives an indication that the financial transaction has or has not been successfully completed via an electronic message and a unique FACM indication. A user of the mobile target device can determine whether the financial transaction has successfully completed or not by listening to the audio output generated from the FACM indication on the mobile target device and does not have to view textual information on the mobile target device.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. A method for determining a status of financial transactions via an audio indication, comprising:
requesting a secure financial transaction be completed between a first application on a mobile target device with one or more processors and a second application on a financial transaction server with one or more processors via a communications network via a first secure message;
sending from the second application on the financial transaction server to the mobile target network device a second secure electronic message with a financial audio communication system (“FACM”) indication including a indicating whether the secure financial transaction has been successfully completed or not;
receiving the second secure electronic message with the FACM indication on the first application on mobile target device and selecting one or more FACM tones indicating whether the secure financial transaction has successfully completed or not, wherein the one or more FACM tones are unique for one of a plurality of operations associated with secure financial transactions;
playing via the first application the selected one or more FACM tones on an audio component on the mobile target device, thereby providing a user of the mobile target device an audio indication of whether the secure financial transaction has successfully completed or not by listening to the audio output generated from the selected one or more FACM tones on the mobile target device and not having to view any electronic information on the mobile target device.

2. A computer readable medium having stored therein instructions for causing one or more processors to executes the steps of the method of claim 1.

3. The method of claim 1 wherein the secure financial transaction is a wireless secure financial transaction.

4. The method of claim 3 wherein the wireless secure financial transaction is completed with a wireless interface on the mobile target device including an IEEE 802.15.4b (ZigBee), IEEE 802.15.1a (Bluetooth), IEEE 802.15.3a (ultra-wideband), an IEEE 802.11a, 802.11b, 802.11g, IEEE 802.11n, IEEE 802.16a or 802.16e (WiMAX), infra-red, an ETSI High Performance Radio Metropolitan Area Network (HIPERMAN) or Voice over Internet Protocol (VoIP) wireless interface.

5. The method of claim 3 wherein the wireless secure financial transaction is completed with a wireless interface on the mobile target device including a Packet Cellular Network (“PCN”) or Global System for Mobile Communications, (“GSM”), Generic Packet Radio Services (“GPRS”), or network/Personal Communications Services network (“PCS”), a Cellular Digital Packet Data (“CDPD”), Wireless Application Protocol (“WAP”) or Digital Audio Broadcasting (“DAB”) network wireless interface.

6. The method of claim 1 further comprising:
sending the second secure electronic message from the financial transaction server to the mobile target device as a confirmation of a status secure financial transaction, wherein the second secure electronic message includes an electronic mail message, an instant message, a text message, a video message, a graphical message or a voice mail message.

7. The method of claim 6 wherein the second secure electronic message includes a secure electronic mail message, instant message, text message, video message, graphical message or voice mail message with an embedded electronic object including the FACM indication to play the one or more FACM tones on the audio component on the mobile target device when activated at a later time.

8. The method of claim 7 wherein the one or more FACM tones include a plurality of unique tones including unique tones for on-line payments, money transfer, banking functions, credit card transactions, debit card transactions, point-of-sale purchases, stock transactions, or commodity transactions, wherein the plurality of unique FACM tones can be created by a user of the mobile target device.

9. The method of claim 8 wherein the point-of-sale purchases include retail stores, grocery stores, convenience stores, gas stations, vending machines or fast food restaurants.

10. The method of claim 7 wherein the embedded electronic object is an embedded audio object or an embedded audio-visual object used to generate an audio or audio-visual indication on the mobile target device of whether the secure financial transaction has successfully completed or not.

11. The method of claim 1 wherein each financial transaction server from a plurality of available financial transaction servers includes a unique set of FACM indications to generate a unique set of FACM tones thereby allowing a user of the mobile target device to distinguish whether the secure financial transaction has successfully completed or not with an audio indication unique to each financial transaction server.

12. A method for determining a status of financial transactions via an audio indication, comprising:
maintaining securely on a first application on financial transaction server with one or more processors and one or more databases a plurality of Financial Audio Communication System (“FACM”) indications for indicating whether a plurality of different secure financial transactions have been successfully completed or not;
receiving a first secure message via a communications network on the first application on the financial transaction server to complete a desired financial transaction;
initiating the desired financial transaction from the first application on the financial transaction server;
sending from the financial transaction server to a second application on a mobile target network device with one or more processors in a second secure electronic message an FACM indication including a indicating whether the secure financial transaction has been successfully completed or not, wherein the second application on the mobile target device uses a FACM indication received in the second secure electronic message from the financial transaction server to play one or more FACM tones on an audio component of the mobile target device indicating whether the financial transaction has successfully completed or not.

13. A computer readable medium having stored therein instructions for causing one or more processors to executes the steps of the method of claim 12.

14. The method of claim 12 wherein the secure financial transaction is a wireless secure financial transaction.

15. The method of claim 12 further comprising:
sending the second secure electronic message from the financial transaction server to the mobile target device as a confirmation of a status secure financial transaction, wherein the second secure electronic message includes an electronic mail message, an instant message, a text message, a video message, a graphical message or a voice mail message.

16. The method of claim 15 wherein the second secure electronic message includes a secure electronic mail message, instant message, text message, video message, graphical message or voice mail message includes an embedded electronic object including the FACM indication to play the one or more FACM tones on the audio component on the mobile target device when activated at a later time.

17. The method of claim 16 wherein the one or more FACM tones include a plurality of unique tones including unique tones for on-line payments, money transfer, banking functions, credit card transactions, debit card transactions, point-of-sale purchases, stock transactions, or commodity transactions, wherein the plurality of unique tones can be created by a user of the mobile target device.

18. The method of claim 17 wherein the point-of-sale purchases include retail stores, grocery stores, convenience stores, gas stations, vending machines or fast food restaurants.

19. A system for determining a status of financial transactions via an audio indication, comprising:
means for requesting a secure financial transaction be completed between a first application on a mobile target device with one or more processors and a second application on a financial transaction server with one or more processors via a communications network;
means for sending from the financial transaction server to the mobile target network device a secure electronic message with a financial audio communication system (“FACM”) indication including a indicating whether the secure financial transaction has been successfully completed or not;
means for receiving the secure electronic message with the FACM indication on the first application on mobile target device and selecting one or more FACM tones indicating whether the secure financial transaction has successfully completed or not, wherein the one or more FACM tones are unique for one of a plurality of operations associated with secure financial transactions; and
means for playing the selected appropriate FACM tone on an audio component via the first application on the mobile target device, thereby providing a user of the mobile target device an audio indication of whether the secure financial transaction has successfully completed or not by listening to the audio output generated from the FACM tone on the mobile target device and not having to view any electronic information on the mobile target device.

20. The system of claim 19 further comprising:
means for maintaining on the second application on the financial transaction server with one or more processors securely maintains one or more databases with a plurality of FACM indications for indicating whether the secure financial transaction has been successfully completed or not;
means for receiving a plurality of secure messages on the second application on the financial transaction server to complete a desired financial transaction;
means for initiating the desired financial transaction from the first application on the financial transaction server;
means for embedding an electronic object in a secure message, when the embedded electronic object includes an FACM indication and is used to play the one or more FACM tones on the audio component on the mobile target device when activated at a later time; and
means for a user creating a unique set of FACM tones corresponding to the plurality of FACM indications.
